(19) United States
(12) Patent Application Publication
(10) Pub. No.: US 2004/0085452 A1
(43) Pub. Date: May 6, 2004

(54) Television receiver

(76) Inventor: Hirokazu Suzu, Osaka (JP)

Correspondence Address: Jonathan P. Osha, ROSENTHAL & OSHA L.L.P., Suite 2800, 1221 McKinney St., Houston, TX, 77010, US

(21) Appl. No.: 10/658,889

(22) Filed: Sep. 10, 2003

(30) Foreign Application Priority Data
Sep. 10, 2002 (JP) UM 2002-005737

(51) Int. Cl. H04N 17/00

(52) U.S. Cl. 348/180

(57) ABSTRACT

In a television receiver, when watching starting time for registered watching reserved information has come, a channel selected at present is a watching reserved channel, and an OSD image has been displayed on a display section, the television receiver stops the display of the OSD image and displays an image of a program which is being broadcasted in the watching reserved channel. This prevents a user from missing the watching reserved program owing to the fact that the user has watched an electronic program guide or a setting menu screen and not noticed that the watching starting time of the program has come.

### BACKGROUND OF THE INVENTION

1. Field of the Invention

This invention relates to a television receiver for displaying/outputting the image of a program that is being broadcasted in a selected channel, and more particularly to a television receiver having a watching reservation function and an OSD image displaying function.

2. Description of the Related Art

Conventionally, a television receiver has been proposed in which a user can conduct watching reservation. By the watching reservation in which watching reservation information that correlates a watching starting time with a channel to be viewed is recorded, when the watching starting time comes, power of a receiver body turns on to start displaying of the image and outputting of voice contained in a program being broadcasted in the reserved channel (e.g. see JP-A-60-251782). This function is referred to as a watching reservation function. This watching reservation function has been proposed to prevent the user from missing a desired program.

In digital television broadcasting, data of a program guide that represents broadcasting starting times of programs whose broadcasting is scheduled, i.e. “electronic program guide (EPG)” is multiplexed with a digital broadcasting signal. A digital television has been put into practice which extracts the EPG from the digital broadcasting signal and displays the EPG as an OSD image on a display screen (see e.g. JP-A-2000-350112). JP-A-2000-350112 also discloses a configuration in which while the EPG is being displayed, if the program being broadcasted in a selected channel is changed into another program, the display of the EPG is stopped and the image of the program now being broadcasted is displayed on a display screen.

Since the watching reservation function in a conventional television receiver only prevents the user from missing his or her desired program, when a watching starting time has come, if the reception of the program being broadcasted in a watching reserved channel is performed, the operating state of the receiver body is maintained. Therefore, in a case in which the user has selected the watching reserved channel and is displaying the OSD image such as the EPG, setting menu image, etc., on the display screen, the display state of the OSD image is kept. This causes a problem in which the user does not notice that the broadcasting of a watching reserved program has been started (watching starting time has come) and misses his or her desired watching reserved program.

Incidentally, JP-A-60-251782 only discloses a configuration in which when the watching starting time has come, the input from an external input terminal is nullified, and the image of the program of the watching reserved channel is displayed. JP-A-60-251782 is entirely silent on the control in the case where the reserved watching starting time has come while the OSD image such as the EPG, setting menu image, etc., is displayed on the display screen.

The configuration disclosed in JP-A-2000-350112 is to stop the display of the OSD image such as the EPG whenever the program being broadcasted is changed. In this configuration, if the program changes in the selected channel while the user performs any recognizing or setting operation with the OSD image such as the EPG, setting menu image, etc., being displayed, the display of the OSD image is stopped regardless of whether or not the program is his or her desired program. This causes a problem that the display of the OSD image is stopped even at a timing when the display of the OSD image is necessary for the user. The user must perform again the operation of displaying the OSD image such as the EPG, setting menu image, etc. This deteriorates the operability of the user.

### SUMMARY OF THE INVENTION

An object of this invention is to provide a television receiver that prevents a user from missing his or her watching reserved program, without deterioration the operability of the user.

A television receiver according to the invention has the following configuration in order to solve the above problems.

(1) A television receiver including:

a receiving section for receiving a television broadcasting signal to extract a signal of a selected channel;

a display control section for controlling a display section to display selectively one of an image of a program being broadcasted in the channel and a synthesized image having the image of the program and an OSD image superposed thereon on the basis of the signal of the selected channel extracted by the receiving section;

a watching reserving section for storing watching reserving information that correlates a watching starting time and a channel with each other; and

a watching reserving executing section for selecting the channel correlated with the watching starting time and operating the receiving section when the watching starting time stored in the watching reserving section has come;

wherein the watching reserving executing section has a change instructing function in which when the watching starting time has come and a television broadcasting signal of the channel correlated with the watching starting time has been received by the receiving section, the watching reserving executing section determines whether or not the display control section has caused the display section to display the OSD image, and if determines that the OSD image has been displayed, the watching reserving executing section instructs the display control section to change the OSD image into an image of a program based on the television broadcasting signal of the channel.

In this configuration, when the watching starting time has come, where the reception of the channel correlated with the watching starting time has been executed by the receiving section, the change instructing function of the watching reserving executing section determines whether or not the display control section has caused the display section to display the OSD image. Now, if determines that the OSD image has been displayed, the change instructing function instructs the display control section to change the OSD image into the image of the program based on the television broadcasting signal of the channel selected for display by the display section. Therefore, even where the OSD image such as an electronic program guide, setting menu image, etc., has been displayed at the watching starting time when watching had been reserved, the display of the OSD image is stopped and the image of a watching reserved program is displayed on the display section. This prevents a user from missing his or her watching reserved program. In addition, the display of the OSD image is not stopped at the other timing than the watching starting time when watching has been reserved by the user. In other words, the display of the OSD image is not stopped at the timing unnecessary for the user, and the operability of the user is not deteriorated.

(2) A television receiver including:

a receiving section for receiving a television broadcasting signal to extract a signal of a selected channel;

a display control section for controlling a display section to display selectively one of an image of a program being broadcasted in the channel and a synthesized image having the image of the program and an OSD image superposed thereon on the basis of the signal of the selected channel extracted by the receiving section;

a watching reserving section for storing watching reserving information that correlates a watching starting time and a channel with each other; and

a watching reserving executing section for selecting the channel correlated with the watching starting time and operating the receiving section when the watching starting time stored in the watching reserving section has come;

wherein the watching reserving executing section has a change instructing function in which when the watching starting time has come and a television broadcasting signal of the channel correlated with the watching starting time has been received by the receiving section, the watching reserving executing section determines whether or not the display control section has caused the display section to display the OSD image, and if determines that the OSD image has been displayed, the watching reserving executing section instructs the display control section to reduce a display size of the OSD image to a predetermined size.

In this configuration, like the above configuration (1), when the watching starting time has come, where the reception of the channel correlated with the watching starting time has been executed by the receiving section, the change instructing function of the watching reserving executing section determines whether or not the display control section has caused the display section to display the OSD image. Now, if determines that the OSD image has been displayed, the change direction function instructs the display control section to reduce the display size of the OSD image to a predetermined size. In this case also, the same effect as in the above configuration (1) can be obtained.

(3) The television receiver may include a setting section for setting the change instructing function of the watching reserving executing section valid or invalid.

In this configuration, the user can set the change instructing function valid or invalid according to the user's own operating ease.

The OSD image in this invention includes not only images of menus for setting various operations in a receiver body, but also an image based of an electronic program guide multiplexed with a television broadcasting signal.

(4) The television receiver may be configured so that when the watching starting time has come and reception of the other channel than the channel correlated with the watching starting time has been executed by the receiving section, the watching reserving executing section instructs the display control section to display a synthesized image having the image of the program which is broadcasted by the channel being received and message superposed thereon that the watching starting time has come.

In this configuration, where the watching starting time has come when the user is watching the program being broadcasted in another channel, the user can know that the watching starting time has come. Further, since the receiver body does not automatically change the receiving channel into a watching reserved channel so that the channel is not changed against a user's intention.

### BRIEF DESCRIPTION OF THE DRAWINGS

FIG. 1 is a block diagram showing a configuration of a television receiver according to an embodiment of the invention;

FIG. 2 is a flowchart showing an operation of the television receiver;

FIG. 3 is a view showing an example of display screen on a display section of the television receiver; and

FIGS. 4A and 4B are views showing examples of display screen on the display section.

### DETAILED DESCRIPTION OF THE PREFFERED EMBODIMENTS

A description will be given of a television receiver according to an embodiment of this invention.

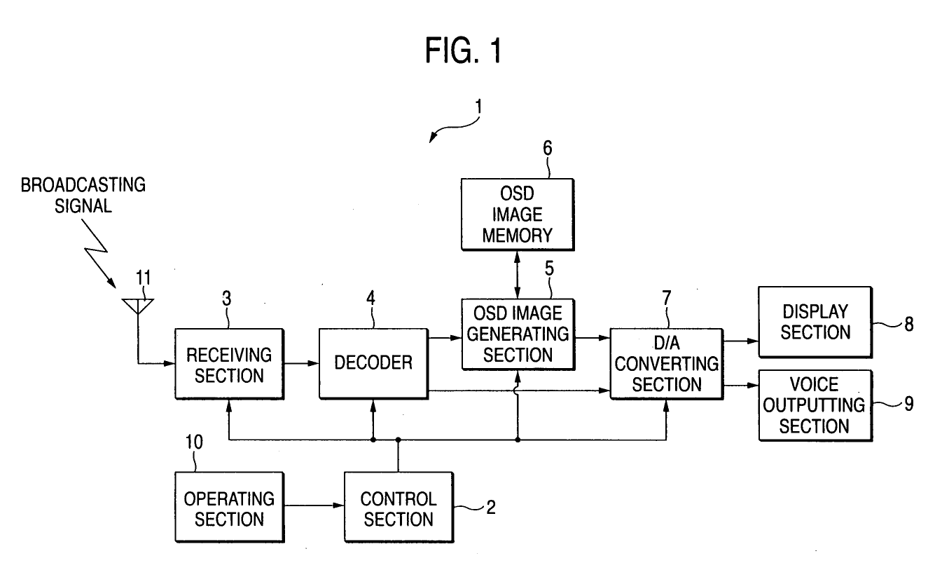

FIG. 1 is a block diagram showing a configuration of the television receiver according to an embodiment of this invention. The television receiver 1 according to this embodiment is an apparatus that can cope with digital television broadcasting. The television receiver 1 includes a control section 2, a receiving section 3, a decoder 4, an OSD image generating section 5, an OSD image memory 6, a D/A converting section 7, a display section 8, a voice outputting section 9 and an operating section 10. The control section 2 serves to control the operation of a receiver body of the television receiver 1. The receiving section is a “tuner” which serves to extract the television broadcasting signal (hereinafter referred to as “broadcasting signal”) received by an antenna 11. The broadcasting signal received by the receiving section 3 is a signal encoded by MPEG2. The broadcasting signal is multiplexed with data of a program guide which represents broadcasting starting times of programs whose broadcasting is scheduled, i.e. “electronic program guide (EPG)”.

The decoder 4 serves to separate a video signal, an audio signal and an EPG signal from the broadcasting signal at the selected channel extracted at the receiving section 3 and decode the respective signals. The OSD image generating section 5 serves to selectively output the OSD image stored in the OSD image memory 6, the EPG or the image of the program. The D/A converting section 7 includes a D/A converting circuit for converting the video signal output from the OSD image generating section into an analog video signal and another D/A converting circuit for converting the audio signal output from the decoder 4 into an analog audio signal.

The display section 8 serves to display the image (either one of the OSD image, EPG and program image) based on the analog video signal output from the D/A converting section 7. The voice outputting section 9 may be a speaker which serves to output the voice based on the analog audio signal output from the D/A converting section 7. The operating section 10 accepts an operation such as channel selective operation in which a channel is extracted at the receiving section 3. Further, another receiving section is provided by which a control command is received from a remote controller (not shown).

In this embodiment, the image that is not the image of the program being broadcasted in a selected channel is defined as the OSD image. This OSD image includes not only the OSD image stored in the OSD image memory but also the image based on the EPG. The OSD image memory stores the OSD image inclusive of setting menu images of various setting data for the receiver body of the television receiver 1.

The control section 2 is provided with a timer which clocks a present time and a memory which stores watching reserving information. The watching reserving information is information which correlates a watching starting time at which watching is started and channel to watch. The watching reserving information can be registered by the operating section 10 or a remote controller (not shown).

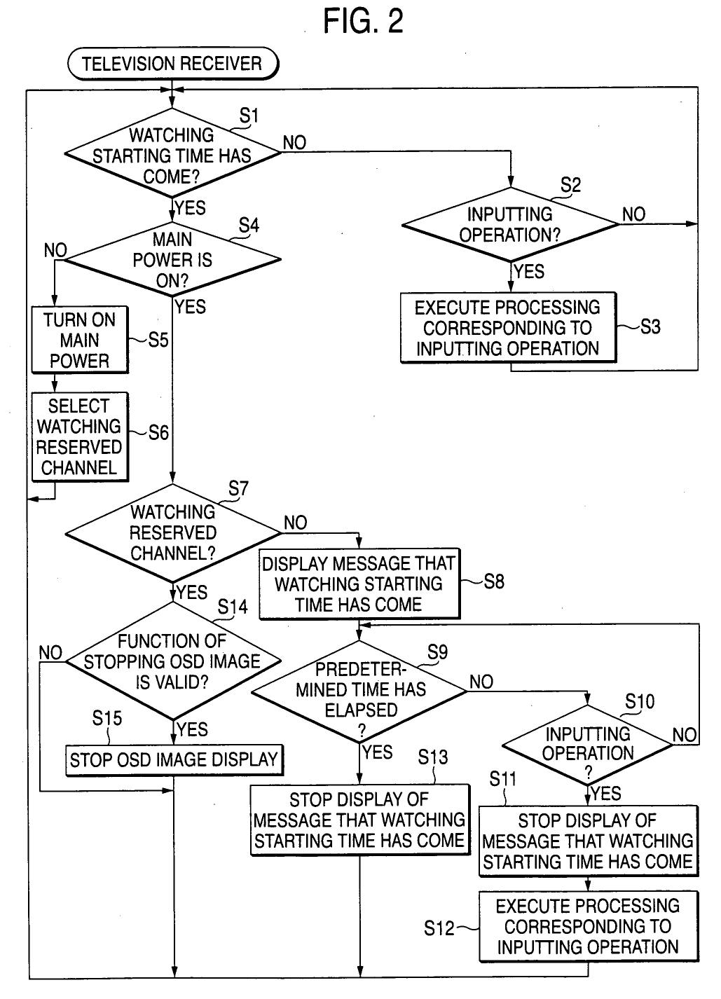

An explanation will be given of an operation of the television receiver 1. FIG. 2 is a flowchart showing the operation of the television receiver.

The television receiver 1 monitors whether or not the watching starting time of the watching reserving information stored in the control section 2 has come and whether or not any inputting operation (inclusive of the reception of a control command transmitted from the remote controller) has been made by the operating section (step S1, S2). When any inputting operation is made by the operating section 10, the television receiver 1 executes the processing corresponding to the inputting operation (step S3), and returns to step S1.

When the present time clocked by the timer reaches the watching starting time, the television receiver 1 determines whether the main power source of the receiver body of the television receiver is in an ON state or in an OFF state (step S4).

Incidentally, irrespectively of whether the main power source is in the ON state or in the OFF state, operation power is supplied to the control section 2.

If the television receiver 1 determines that the main power source is in the OFF state, it turns on the main power source, and changes the receiving channel into a channel correlated with the watching starting time (step S5, S6). Thus, the television receiver 1 starts to receive the broadcasting signal based on the registered watching reserving information so that the image of a watching reserved program is displayed and the voice of the program is output from the voice outputting section 9.

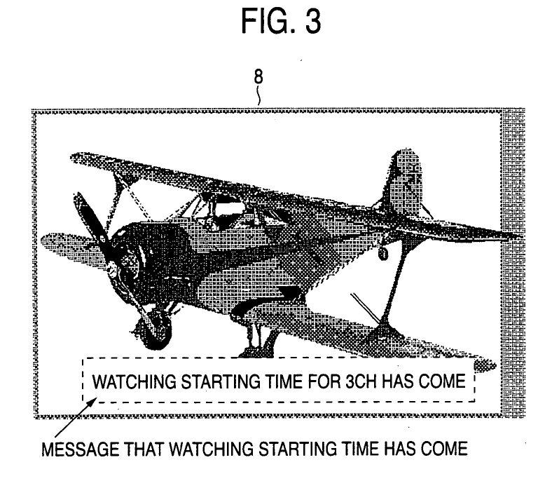

On the other hand, if the television receiver 1 determines that the main power source is in the ON state, it further determines whether or not the channel selected at present is the channel correlated with a pertinent watching starting time (step S7). If the television receiver 1 determines that the channel selected at present is not the channel correlated with the pertinent watching starting time, the OSD image generating section 5 generates a synthesized image composed of the image of the program which is being broadcasted in the channel selected at present and message superposed thereon that the watching starting time has come. This synthesized image is display on the display section 8 (step S8) (see FIG. 3).

The generation of the synthesized image in step S8 is continued until any inputting operation is made by the operating section 10, or a predetermined time, e.g. 2 to 3 seconds elapses (step S9, S10). If any operation is made during this period, the display started in step S8 of the message that the watching starting time has come is stopped. The processing corresponding to the inputting operation is executed (S12). For example, if the user knows that the watching starting time has come from the display started in step S8 of the message that the watching starting time has come, and changes the receiving channel into the watching reserved channel, the operation of changing the receiving channel into the watching received channel is executed.

In this way, where the user is watching the program being broadcasted in another channel when the watching starting time of the registered watching reserving information has come, the message that the watching starting time has come is displayed as the OSD image. Therefore, the user can surely know that the watching reserving time has come. This permits the user to change smoothly the receiving channel into the watching reserved channel in which the watching reserved program is broadcasted, so that the user does not miss the watching reserved program.

In this case, the receiving channel is not changed automatically, but changed on the basis of the user's intention. Therefore, where the user hopes to watch the program that the user is now watching, not but the watching reserved program, the channel is not abruptly changed in the channel of the watching reserved program so that the user does not feel unpleasant sense.

Where no inputting operation is made by the operating section 10, when a certain period elapses, the display started in step S8 of the message that the watching starting time has come is stopped (S13). Therefore, where the user hopes to watch continuously the program that the user is now watching, the message that the watching starting time has come will not be displayed continuously, thereby not hindering the user's watching.

If the television receiver 1 determines that the channel selected at present in step S7 is the channel correlated with the pertinent watching starting time, it further determines whether the function of stopping the OSD image display (change instructing function) has been set valid or invalid (step S14). Setting the function of stopping the OSD image display valid or invalid can be carried out by the operating section or remote controller. If the function of stopping the OSD image display is set invalid, the television receiver 1 continues the display of the OSD image being displayed now on the display section 8. On the contrary, if the function of stopping the OSD image display is set valid, the television receiver 1 stop the display of the OSD image being displayed now on the display section 8, and displays on the display section 8 the image of the program which is being broadcasted in the watching reserved channel (step S15).

Therefore, if the user sets the function of stopping the OSD image display valid, when the watching starting time of the registered watching reserved program has come, even when the OSD image such as the EPG or setting menu image has been displayed on the display section 8, the image of the watching reserved program is automatically displayed on the display section 8. Thus, the user does not miss the watching reserved program. The user who does not require this function may set the function of stopping the OSD image display invalid.

In this way, without deteriorating the operability of the user, the user can surely watch the watching reserved program.

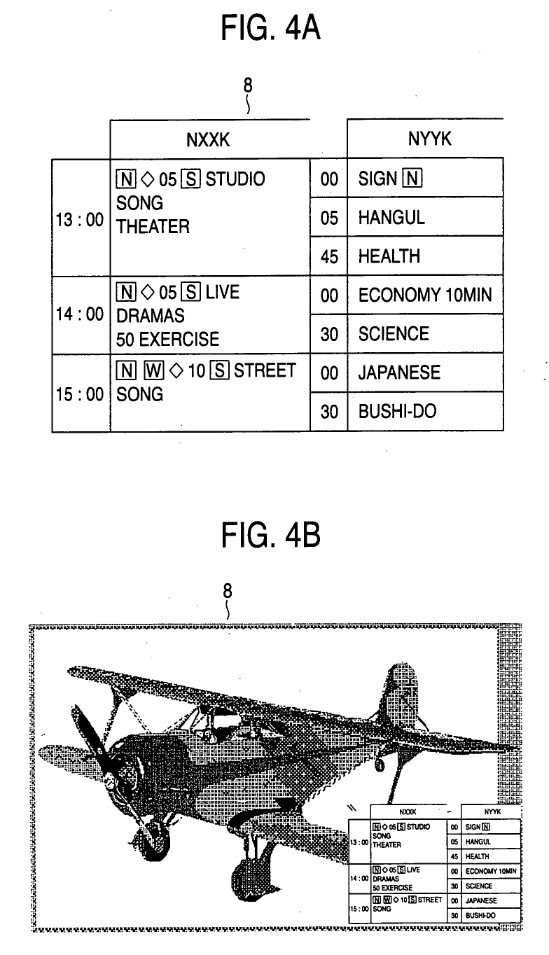

In this embodiment, although the display of the OSD image was stopped in step S15, the OSD image display on the display section 8 may be displayed in a reduced area (see FIGS. 4A and 4B). FIG. 4A shows a displayed image on the display section 8 immediately before the watching starting time comes. FIG. 4B shows a displayed image on the display section immediately after the watching starting time has come. In this case, the OSD image is preferably reduced to the size that does not hinder the user from watching the image of the program being broadcasted in a user's selected channel. For example, the size is preferably ⅓ as large as the screen size of the display section 8.

In this embodiment, the invention was applied to a television receiver that can cope with digital broadcasting, but the invention may be applied to a television receiver that can cope with analog broadcasting.

As understood from the description hitherto made, in accordance with this invention, even when the OSD image has been displayed at the watching starting time of the watching reserved program, the user does not miss the watching reserved program, and the display of the OSD image is not stopped at timing not required for the user. In this way, without deteriorating the operability of the user, the user can surely watch the watching reserved program.

What is claimed is:

1. A television receiver comprising:
a receiving section for receiving a television broadcasting signal to extract a signal of a selected channel;
a display control section for controlling a display section to display selectively one of an image of a program being broadcasted in the channel and a synthesized image composed of the image of the program and an OSD image superposed thereon on the basis of the signal of the selected channel extracted by the receiving section;
a watching reserving section for storing watching reserving information that correlates a watching starting time and a channel with each other;
a watching reserving executing section for selecting the channel correlated with the watching starting time and operating the receiving section when the watching starting time stored in the watching reserving section has come; and
a setting section;
wherein the watching reserving executing section has a change instructing function in which when the watching starting time has come and a television broadcasting signal of the channel correlated with the watching starting time has been received by the receiving section, the watching reserving executing section determines whether or not the display control section has caused the display section to display the OSD image, and if determines that the OSD image has been displayed, the watching reserving executing section instructs the display control section to change the OSD image into an image of a program based on the television broadcasting signal of the channel;
when the watching starting time has come and reception of the other channel than the channel correlated with the watching starting time has been executed by the receiving section, the watching reserving executing section instructs the display control section to display a synthesized image composed of the image of the program which is broadcasted by the channel being received and message superposed thereon that the watching starting time has come;
the OSD image includes an image based on electronic program guide information contained in the received television broadcasting signal; and
the setting section sets the change instructing function of the watching reserving executing section valid or invalid.

2. A television receiver comprising:
a receiving section for receiving a television broadcasting signal to extract a signal of a selected channel;
a display control section for controlling a display section to display selectively one of an image of a program being broadcasted in the channel and a synthesized image composed of the image of the program and an OSD image superposed thereon on the basis of the signal of the selected channel extracted by the receiving section;
a watching reserving section for storing watching reserving information that correlates a watching starting time and a channel with each other;
a watching reserving executing section for selecting the channel correlated with the watching starting time and operating the receiving section when the watching starting time stored in the watching reserving section has come; and
a setting section;
wherein the watching reserving executing section has a change instructing function in which when the watching starting time has come and a television broadcasting signal of the channel correlated with the watching starting time has been received by the receiving section, the watching reserving executing section determines whether or not the display control section has caused the display section to display the OSD image, and if determines that the OSD image has been displayed, the watching reserving executing section instructs the display control section to reduce a display size of the OSD image to a predetermined size;
when the watching starting time has come and reception of the other channel than the channel correlated with the watching starting time has been executed by the receiving section, the watching reserving executing section instructs the display control section to display a synthesized image composed of the image of the program which is broadcasted by the channel being received and message superposed thereon that the watching starting time has come;
the OSD image includes an image based on electronic program guide information contained in the received television broadcasting signal; and
the setting section sets the change instructing function of the watching reserving executing section valid or invalid.

3. A television receiver comprising:
a receiving section for receiving a television broadcasting signal to extract a signal of a selected channel;
a display control section for controlling a display section to display selectively one of an image of a program being broadcasted in the channel and a synthesized image having the image of the program and an OSD image superposed thereon on the basis of the signal of the selected channel extracted by the receiving section;
a watching reserving section for storing watching reserving information that correlates a watching starting time and a channel with each other; and
a watching reserving executing section for selecting the channel correlated with the watching starting time and operating the receiving section when the watching starting time stored in the watching reserving section has come;
wherein the watching reserving executing section has a change instructing function in which when the watching starting time has come and a television broadcasting signal of the channel correlated with the watching starting time has been received by the receiving section, the watching reserving executing section determines whether or not the display control section has caused the display section to display the OSD image, and if determines that the OSD image has been displayed, the watching reserving executing section instructs the display control section to change the OSD image into an image of a program based on the television broadcasting signal of the channel.

4. A television receiver comprising:
a receiving section for receiving a television broadcasting signal to extract a signal of a selected channel;
a display control section for controlling a display section to display selectively one of an image of a program being broadcasted in the channel and a synthesized image having the image of the program and an OSD image superposed thereon on the basis of the signal of the selected channel extracted by the receiving section;
a watching reserving section for storing watching reserving information that correlates a watching starting time and a channel with each other; and
a watching reserving executing section for selecting the channel correlated with the watching starting time and operating the receiving section when the watching starting time stored in the watching reserving section has come;
wherein the watching reserving executing section has a change instructing function in which when the watching starting time has come and a television broadcasting signal of the channel correlated with the watching starting time has been received by the receiving section, the watching reserving executing section determines whether or not the display control section has caused the display section to display the OSD image, and if determines that the OSD image has been displayed, the watching reserving executing section instructs the display control section to reduce a display size of the OSD image to a predetermined size.

5. The television receiver according to claim 3, further comprising a setting section for setting the change instructing function of the watching reserving executing section valid or invalid.

6. The television receiver according to claim 4, further comprising a setting section for setting the change instructing function of the watching reserving executing section valid or invalid.

7. The television receiver according to claim 3, wherein the OSD image includes an image based on electronic program guide information contained in the received television broadcasting signal.

8. The television receiver according to claim 4, wherein the OSD image includes an image based on electronic program guide information contained in the received television broadcasting signal.

9. The television receiver according to claim 3, wherein when the watching starting time has come and reception of the other channel than the channel correlated with the watching starting time has been executed by the receiving section, the watching reserving executing section instructs the display control section to display a synthesized image having the image of the program which is broadcasted by the channel being received and message superposed thereon that the watching starting time has come.

10. The television receiver according to claim 4, wherein when the watching starting time has come and reception of the other channel than the channel correlated with the watching starting time has been executed by the receiving section, the watching reserving executing section instructs the display control section to display a synthesized image having the image of the program which is broadcasted by the channel being received and message superposed thereon that the watching starting time has come.
